(19) United States
(12) Patent Application Publication
(10) Pub. No.: US 2017/0364222 A1
(43) Pub. Date: Dec. 21, 2017

(54) SYSTEM FOR INTERNETWORKED MONITORING AND COMMUNICATION TRIGGERING

(71) Applicant: BANK OF AMERICA CORPORATION, Charlotte, NC (US)

(72) Inventor: Manu Jacob Kurian, Dallas, TX (US)

(21) Appl. No.: 15/185,529

(22) Filed: Jun. 17, 2016

(51) Int. Cl. G06F 3/0484; H04L 29/08; G06F 3/0482

(52) U.S. Cl. CPC G06F 3/0484; G06F 3/0482; H04L 67/10

(57) ABSTRACT

Systems, computer program products, and methods are described herein for inter-networked monitoring and communication triggering across a dispersed Internet protocol capable network connecting one or more smart devices connected to the dispersed network. The present invention is configured to provide an alert triggering application for installation on the one or more smart devices associated with a user; receive an indication of a user action executed using at least one of the one or more smart devices; detect an incidence of a trigger event based on at least receiving the indication of the user action executed using at least one of the one or more smart devices; establish a communication link with each of the one or more smart devices based on at least detecting the incidence of the trigger event; display, via the alert triggering application, an alert indicating the occurrence of the trigger event.

### BACKGROUND

With advancements in machine and product development, more and more objects such as devices, vehicles, buildings, machines, or the like, are becoming interconnected via network channels thereby forming a network of physical objects. In this way, these objects can be configured to be sensed and controlled remotely across existing network infrastructure and creating opportunities for more direct integration of the objects into the physical world. In such an environment, there is a need for a system for internetworked monitoring and communication triggering.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for inter-networked monitoring and communication triggering across a dispersed Internet protocol capable network connecting one or more smart devices connected to the dispersed network is presented. The system comprises at least one memory; at least one processing device operatively coupled to the memory device, wherein the processing device is configured to execute computer-readable program code to: provide an alert triggering application for installation on the one or more smart devices associated with a user; receive an indication of a user action executed using at least one of the one or more smart devices; detect an incidence of a trigger event based on at least receiving the indication of the user action executed using at least one of the one or more smart devices; establish a communication link with each of the one or more smart devices based on at least detecting the incidence of the trigger event, wherein establishing further comprises activating the alert triggering application stored on each of the one or more smart devices; transmit control signals configured to cause a display device associated with each of the one or more smart devices to display, via the alert triggering application, an alert indicating the occurrence of the trigger event.

In some embodiments, the module is further configured to: transmit control signals configured to execute one or more actions, via the alert triggering application, on each of the one or more smart devices.

In some embodiments, the module is further configured to: initiate a presentation of a user interface for display on a user device, wherein the user interface comprises the one or more actions to be executed in response to the occurrence of the triggering event; and receive, via the user interface, a user selection of one or more actions to be executed on each of the one or more smart devices in response to the occurrence of the triggering event.

In some embodiments, the one or more actions comprises restricting one or more features associated with each of the one or more smart devices.

In some embodiments, the module is further configured to: determine an impact score for each of the one or more smart devices based on at least detecting the incidence of the trigger event, wherein the impact score indicates an impact of the trigger event on each of the one or more smart devices; determine one or more features associated with each of the one or more smart devices to be restricted based on at least the impact score; and transmit control signals configured to restrict the one or more features associated with each of the one or more smart devices.

In some embodiments, the module is further configured to: transmit control signals configured to disable a radio circuit configured to connect each of the one or more smart devices to the dispersed network, wherein disabling further comprises disconnecting each of the one or more smart devices from the dispersed network.

In some embodiments, the module is further configured to: transmit control signals configured to disable one or more devices associated with each of the one or more smart devices, wherein disabling further comprises disconnecting the one or more devices associated with each of the one or more smart devices from the dispersed network.

In another aspect, a computerized method for inter-networked monitoring and communication triggering across a dispersed Internet protocol capable network connecting one or more smart devices connected to the dispersed network is presented. The method comprises: providing, using a computing device processor, an alert triggering application for installation on the one or more smart devices associated with a user; receiving, using a computing device processor, an indication of a user action executed using at least one of the one or more smart devices; detecting, using a computing device processor, an incidence of a trigger event based on at least receiving the indication of the user action executed using at least one of the one or more smart devices; establishing, using a computing device processor, a communication link with each of the one or more smart devices based on at least detecting the incidence of the trigger event, wherein establishing further comprises activating the alert triggering application stored on each of the one or more smart devices; transmitting, using a computing device processor, control signals configured to cause a display device associated with each of the one or more smart devices to display, via the alert triggering application, an alert indicating the occurrence of the trigger event.

In yet another aspect, a computer program product for inter-networked monitoring and communication triggering across a dispersed Internet protocol capable network connecting one or more smart devices connected to the dispersed network is presented. The computer program product comprising a non-transitory computer-readable medium comprising code causing a first apparatus to: provide an alert triggering application for installation on the one or more smart devices associated with a user; receive an indication of a user action executed using at least one of the one or more smart devices; detect an incidence of a trigger event based on at least receiving the indication of the user action executed using at least one of the one or more smart devices; establish a communication link with each of the one or more smart devices based on at least detecting the incidence of the trigger event, wherein establishing further comprises activating the alert triggering application stored on each of the one or more smart devices; and transmit control signals configured to cause a display device associated with each of the one or more smart devices to display, via the alert triggering application, an alert indicating the occurrence of the trigger event

### BRIEF DESCRIPTION OF THE DRAWINGS

Having thus described embodiments of the invention in general terms, reference will now be made to the accompanying drawings, where:

FIG. 1 illustrates system environment for inter-networked monitoring and communication triggering across a dispersed Internet protocol capable network connecting one or more smart devices connected to the dispersed network, in accordance with one embodiment of the present invention;

FIG. 2 illustrates a smart device system environment, in accordance with an embodiment of the invention;

FIG. 3 provides a high level process flow for a system for inter-networked monitoring and communication triggering across a dispersed Internet protocol capable network connecting one or more smart devices connected to the dispersed network, in accordance with an embodiment of the invention;

FIG. 4 provides a high level process flow for determining an impact of a trigger event for a system for inter-networked monitoring and communication triggering across a dispersed Internet protocol capable network connecting one or more smart devices connected to the dispersed network, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. For clarity, non-essential elements may have been omitted from some of the drawing.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

As used herein, the term “resource” will generally refer to objects, products, goods, commodities, services, and the like, and/or the ability and opportunity to view, access and use the same. Some example implementations herein contemplate property held by a user, including property that is stored and/or maintained by a third party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. Examples of resources that may not necessarily be associated with accounts may be particularized goods, such as distinct pieces of furniture, equipment, or other valuables, or the like. Similarly, “funds” or “available balance” refer to types of resources. For example, the term “fund” may be used to refer to one or more sets of monetary resources available to a user, and may also be referred to as an available balance, a collected balance, good funds, and usable funds.

In accordance with embodiments of the invention, the terms “financial institution” and “financial entity” or “entity” may include any organization that processes financial transactions including, but not limited to, banks, credit unions, savings and loan associations, investment companies, stock brokerages, asset management firms, insurance companies and the like.

Many of the example embodiments and implementations described herein contemplate interactions engaged in by a resource user with a computing device (e.g., a smart device) and/or one or more resource access communication devices and/or secondary communication devices. A “user”, as referenced herein, may refer to an entity or individual that has the ability and/or authorization to access and use one or more resources or portions of a resource. Furthermore, as used herein, the term “user computing device” or “mobile device” may refer to mobile phones, personal computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

In some example implementations, a resource access communication device is capable of interacting with a user in the sense that it can detect and parse audible statements from a user (including but not limited to spoken commands, spoken questions, and other user speech) and/or written content from a user (including but not limited to text input by a user and/or other written commands or statements), and responding to the user in the form of performing transactions, transmitting credentials, establishing communication channels, prompting the user to perform one or more actions, scheduling meetings with personnel associated with one or more resources, and the like.

Many example implementations are particularly directed to a user's interaction with resources associated with the user and stored or otherwise associated with a third party financial institution. In some such implementations, a resource access communication device, as either a stand-alone device or one integrated into a user computing device, is capable of interacting with a banking application to facilitate the efficient and effective access, monitoring, deployment, and accumulation of resources by the user. For example, a resource access communication device that is capable of detecting and processing voice commands may be used by a user to translate statements made by the user, into operative transactions, such as the satisfaction of obligations, transfers of resources, subscription to certain products and/or services, responding to offers, and the like. Similarly, a resource access communication device that is capable of detecting and processing written statements from a user, such as text messages or other written messages may likewise be used to effectuate transactions and operations associated with resources and otherwise respond to user input.

Some example implementations contemplate resource access communication devices that are able to detect, parse, and respond to predetermined command words or phrases, colloquial and/or non-specific language, and/or other natural language in a manner that allows a user to effectively monitor and manage their resource usage. For example, such a resource access communication device may be capable of recognizing a statements such as “check my transaction history”, “pay all outstanding obligations”, or other similar declarative commands, and, in response to such commands, perform the requested operation, such as providing a copy of the user's transaction history (or a portion thereof, as requested), or such as initiating transactions to pay any bills or other obligations that have not yet been paid. In another example, a resource access communication device may be able to respond to questions such as “has my paycheck been deposited”, “am I on track to retire”, “tell me about this transaction I don't recognize” by requesting and receiving the appropriate data set and/or message information, and conveying it to the user. In another example, a resource access communication device may be configured to perform operations based on other input received from the user and/or information received from one or more third parties or other sources. In one such example, a user may articulate that certain items should be added to a grocery or other shopping list, that one or more goods or services are necessary for a home or vehicle, or the like. In response to the user input, the resource access communication device may locate and/or compile offers associated with the goods, services, and/or other products associated with the statements made by the user, and convey those offers and/or other information to the user.

While some example implementations contemplate a resource access communication device and/or module that is integrated into one or more smart devices associated with the user, some example implementations contemplate one or more stand-alone resource access communication devices and/or one or more secondary communications devices. Some users may derive particularized benefits by having secondary communication devices deployed in advantageous positions around a home, workspace, or other locations, wherein such secondary communication devices are capable of communicating user input to a resource access communication device and relaying information back to the user. For example, a user may opt to position one secondary communication device in a kitchen, and recite items that may be needed for the completion of a particular recipe or a grocery list. The secondary communication device can in turn relay the information to a resource access communication device for further processing, and relay back to the user any response from the resource access communication device. Similarly, a user may opt to position a secondary communication device near where the user often processes mail or other correspondence, such that the user can provide instructions to pay bills or otherwise interact with service providers, entities associated with offers received by the user, and other entities associated with correspondence received by the user. Those skilled in the art will appreciate that a user may opt to position such secondary communication devices in any location where it may be advantageous to be able to issue speaking and/or written commands or statements to provide information about potential resource uses, initiate transactions, and/or otherwise monitor the status and use of resources.

In some embodiments, the smart devices may be associated with a network of physical objects such as devices, vehicles, buildings, machines, or the like embedded with network connectivity that allow for the objects to collect and exchange data. This exchange allows for objects to be sensed and monitored remotely for maintenance, predictive failures, updates, alerts, or the like, thereby creating opportunities for more direct integration of the physical world into computer-based systems, and resulting in improved efficiency, accuracy and economic benefit. When objects are augmented with sensors and actuators, the technology allows products to be interoperate within existing network infrastructures.

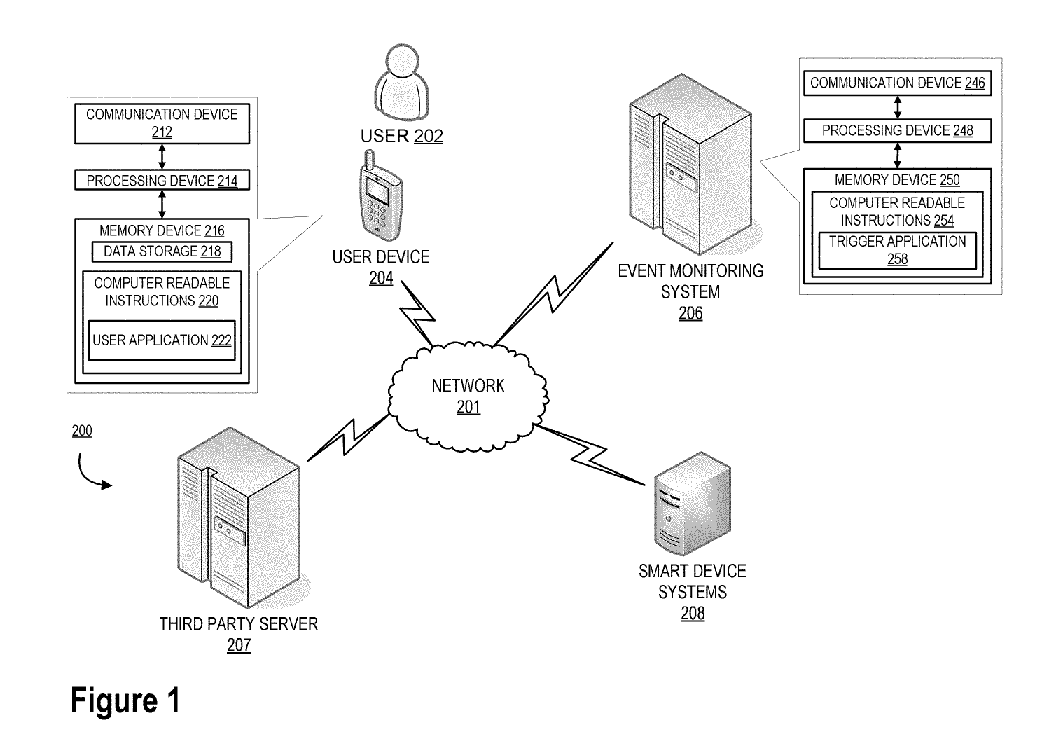

FIG. 1 illustrates system environment for inter-networked monitoring and communication triggering across a dispersed Internet protocol capable network connecting one or more smart devices connected to the dispersed network 200, in accordance with one embodiment of the present invention. FIG. 1 provides the system environment 200 for which the distributive network system with specialized data feeds associated with the event monitoring. FIG. 1 provides a unique system that includes specialized servers and system communicably linked across a distributive network of nodes required to perform the functions of resource allocation, event monitoring, trigger detection, and implementation of consequential actions based on smart device data compilation.

As illustrated in FIG. 1, the smart device system 208 is operatively coupled, via a network 201 to the user device 204, third party servers 207, and to the event monitoring system 206. In this way, the smart device systems 208 can send information to and receive information from the user device 204, third party servers 207, and the event monitoring system 206. FIG. 1 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 has a user device, such as a mobile phone, tablet, computer, or the like. FIG. 1 also illustrates a user device 204. The user device 204 may be, for example, a desktop personal computer, a mobile system, such as a cellular phone, smart phone, personal data assistant (PDA), laptop, or the like. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the event monitoring system 206, the smart device systems 208, and the distributor sever 207. As such, the communication device 212 generally comprises a modem, server, or other device for communicating with other devices on the network 201.

The user device 204 comprises computer-readable instructions 220 and data storage 218 stored in the memory device 216, which in one embodiment includes the computer-readable instructions 220 of a user application 222. In some embodiments, the user application 222 allows a user 202 to send and receive communications with the event monitoring system 206.

As further illustrated in FIG. 1, the event monitoring system 206 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the smart device systems 208, the third party server 207, and the user device 204. As such, the communication device 246 generally comprises a modem, server, or other device for communicating with other devices on the network 201.

As further illustrated in FIG. 1, the event monitoring system 206 comprises computer-readable instructions 254 stored in the memory device 250, which in one embodiment includes the computer-readable instructions 254 of a trigger application 258. In some embodiments, the memory device 250 includes data storage 252 for storing data related to the system environment, but not limited to data created and/or used by the trigger application 258.

In one embodiment of the event monitoring system 206 the memory device 250 stores a trigger application 258. In one embodiment of the invention, the trigger application 258 may be associated with applications having computer-executable program code that detect the occurrence of a trigger event and execute corresponding actions. Furthermore, the event monitoring system 206, using the processing device 248 codes certain communication functions described herein. In one embodiment, the computer-executable program code of an application associated with the trigger application 258 may also instruct the processing device 248 to perform certain logic, data processing, actions, and data storing functions of the application.

The processing device 248 is configured to use the communication device 246 to communicate with and ascertain data from one or more smart device systems 208. In the embodiment illustrated in FIG. 1 and described throughout much of this specification, the trigger application 258 may be coded for smart device system 208 communication for determining a trigger event. As such, the trigger application 258 may receive communications from the smart device systems 208, decrypt and standardize the received communications such that the communications are compatible with the system, and analyze the communications received.

As illustrated in FIG. 1, the third party server 207 is connected to the smart device systems 208, user device 204, and event monitoring system 206. The third party server 207 has the same or similar components as described above with respect to the user device 204 and the event monitoring system 206. While only one third party server 207 is illustrated in FIG. 1, it is understood that multiple third party servers 207 may make up the system environment 200. The third party server 207 may be associated with one or more financial institutions, insurance corporations, inspection providers, permit providers, material providers, resource allocators and the like.

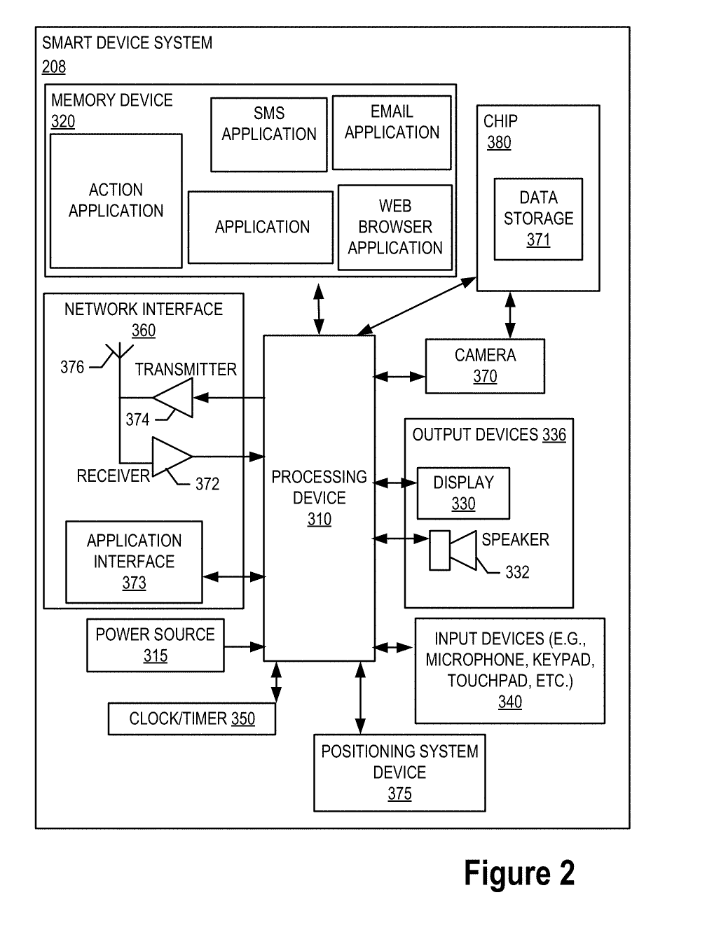

As illustrated in FIG. 1, the smart device systems 208 is connected to the third party server 207, user device 204, and event monitoring system 206. The smart device systems 208 is further detailed below with respect to FIG. 2. The smart device systems 208 has the same or similar components as described above with respect to the user device 204 and the event monitoring system 206. While only one smart device system 208 is illustrated in FIG. 1, it is understood that multiple smart device systems 208 may make up the system environment 200. It is understood that the servers, systems, and devices described herein illustrate one embodiment of the invention. It is further understood that one or more of the servers, systems, and devices can be combined in other embodiments and still function in the same or similar way as the embodiments described herein.

FIG. 2 illustrates a smart device system environment, in accordance with an embodiment of the invention. A “smart device” or “smart device system” as used herein means a device, apparatus and/or system that is capable of communicating with and transmitting information or data to and/or receiving information or data from other devices, systems or apparatuses including over network 201. The smart device system 208 may be for example, but not limited to, a machine such as an automobile, tractor trailer, airplane, manufacturing device, warehouse devices, material handling system, conveyor system, robotics or the like; appliances such as refrigerators, washer/dryers, dish washers, or the like; home entertainment devices or systems such as set top boxes, gaming systems, internet televisions, or the like; home or building systems such as home security systems, utility systems such as electrical, water, plumbing systems and apparatuses such as electric meters, water meters, hot water heaters, gas meters or the like; and personal devices such as wearable devices such as internet capable fitness devices, watches, glasses or the like. The list of smart devices provided herein is not exhaustive such that the smart device system 208 may be any device that includes a communication interface or module, software and/or hardware that allow the device to communicate data and/or information related to the device with other devices and/or systems over network 201.

The smart device systems 208 may generally include a processing device 310 communicably coupled to devices as a memory device 320, output devices 336, input devices 340, a network interface 360, a power source 315, a clock or other timer 350, a camera 370, a positioning system device 375, one or more chips 380, and the like.

The processing device 310 is operatively coupled to the network communication interface 360 and the memory device 320. The smart device may also have a control system for controlling the physical operation of the device. The control system may comprise one or more sensors for detecting operating conditions of the various mechanical and electrical systems that comprise the smart device or of the environment in which the smart device is used. The sensors may communicate with the processing device 310 to provide feedback to the operating systems of the device. The control system may also comprise metering devices for measuring performance characteristics of the smart device. The control system may also comprise controllers such as programmable logic controllers (PLC), proportional integral derivative controllers (PID) or other machine controllers. The smart device may also comprise various electrical, mechanical, hydraulic or other systems that perform various functions of the smart device. These systems may comprise, for example, electrical circuits, motors, compressors, or any system that enables functioning of the smart device

The processing device 310 may include functionality to operate one or more software programs or applications, which may be stored in the memory device 320. For example, the processing device 310 may be capable of operating a connectivity program, such as a web browser application. In this way, the smart device systems 208 may transmit and receive web content, such as, for example, product valuation, location-based content, and/or other web page content, according to a Wireless Application Protocol (WAP), Hypertext Transfer Protocol (HTTP), and/or the like.

The processing device 310 may also be capable of operating one or more applications. The one or more applications may be downloaded from a server and stored in the memory device 320 of the smart device systems 208. Alternatively, the one or more applications may be pre-installed and stored in a memory in the chip 380.

In such an embodiment, the smart device systems 208 may previously store the one or more applications prior to affixing the smart device systems 208 to the product. In this way the one or more applications may remain and be stored on the smart device systems 208.

In some embodiments, the smart device systems 208 access one or more databases or datastores (not shown) to search for and/or retrieve information related to the device. In some embodiments, the smart device systems 208 access both a memory and/or datastore local to the smart device systems 208 as well as a datastore remote from the smart device systems 208.

The chip 380 may include the necessary circuitry to provide data gathering and presentation functionality to the smart device systems 208. Generally, the chip 380 will include data storage 371 which may include data associated with the products that the smart device systems 208. The tag chip 380 and/or data storage 371 may be an integrated circuit, a microprocessor, a system-on-a-chip, a microcontroller, or the like. In this way, the chip 308 will included data storage 371 which may include data associated with the presentment application 321.

Of note, while FIG. 2 illustrates the chip 380 as a separate and distinct element within the smart device systems 208, it will be apparent to those skilled in the art that the chip 380 functionality may be incorporated within other elements in the smart device systems 208. For instance, the functionality of the chip 380 may be incorporated within the memory device 320 and/or the processing device 310. In a particular embodiment, the functionality of the chip 380 is incorporated in an element within the smart device systems 208 that provide use information, product activity, product depletion, and the like to the smart device systems 208. Still further, the chip 380 functionality may be included in a removable storage device such as an SD card or the like.

The processing device 310 may be configured to use the network interface 360 to communicate with one or more other devices on a network 201. In this regard, the network interface 360 may include an antenna 376 operatively coupled to a transmitter 374 and a receiver 372 (together a “transceiver”). The processing device 310 may be configured to provide signals to and receive signals from the transmitter 374 and receiver 372, respectively. The signals may include signaling information in accordance with the air interface standard of the applicable cellular system of the wireless telephone network that may be part of the network 201. In this regard, the smart device systems 208 may be configured to operate with one or more air interface standards, communication protocols, modulation types, and access types. By way of illustration, the smart device systems 208 may be configured to operate in accordance with any of a number of first, second, third, and/or fourth-generation communication protocols and/or the like. For example, the smart device systems 208 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The smart device systems 208 may also be configured to operate in accordance with non-cellular communication mechanisms, such as via a wireless local area network (WLAN) or other communication/data networks.

The network interface 360 may also include an application interface 373 in order to allow a user 202 to execute some or all of the above-described processes with respect to the presentment application 321 and/or the chip 380. The application interface 373 may have access to the hardware, e.g., the transceiver, and software previously described with respect to the network interface 360. Furthermore, the application interface 373 may have the ability to connect to and communicate with an external data storage on a separate system within the network 201.

The smart device systems 208 may have an interface that includes user output devices 336 and/or input devices 340. The output devices 336 may include a display 330 (e.g., a liquid crystal display (LCD) or the like) and a speaker 332 or other audio device, which are operatively coupled to the processing device 310. The input devices 340, which may allow the smart device systems 208 to receive data from a user 202, may include any of a number of devices allowing the smart device systems 208 to receive data from a user 202, such as a keypad, keyboard, touch-screen, touchpad, microphone, mouse, joystick, other pointer device, button, soft key, and/or other input device(s).

The smart device systems 208 may further include a power source 315. Generally, the power source 315 is a device that supplies electrical energy to an electrical load. In some embodiment, power source 315 may convert a form of energy such as solar energy, chemical energy, mechanical energy, or the like to electrical energy. Generally, the power source 315 in a smart device systems 208 may be a battery, such as a lithium battery, a nickel-metal hydride battery, or the like, that is used for powering various circuits, e.g., the transceiver circuit, and other devices that are used to operate the mobile device 204. Alternatively, the power source 315 may be a power adapter that can connect a power supply from a power outlet to the smart device systems 208. In such embodiments, a power adapter may be classified as a power source “in” the smart device systems 208.

The smart device systems 208 may also include a memory device 320 operatively coupled to the processing device 310. As used herein, memory may include any computer readable medium configured to store data, code, or other information. The memory device 320 may include volatile memory, such as volatile Random Access Memory (RAM) including a cache area for the temporary storage of data. The memory device 320 may also include non-volatile memory, which can be embedded and/or may be removable. The non-volatile memory may additionally or alternatively include an electrically erasable programmable read-only memory (EEPROM), flash memory or the like.

The memory device 320 may store any of a number of applications or programs which comprise computer-executable instructions/code executed by the processing device 310 to implement the functions of the smart device systems 208 described herein. For example, the memory device 320 may include the one or more applications.

In some embodiments, the smart device systems 208 may identify the activity or use of the product. The smart device systems 208 may do this via the positioning system device 375, camera 370, and the like. As such, the smart device systems 208 may identify when the product is being used, how often it is being used, and the like. Furthermore, the smart device systems 208 may identify when maintenance may be required based on an identification of the product and regular maintenance required for that product to be maintained.

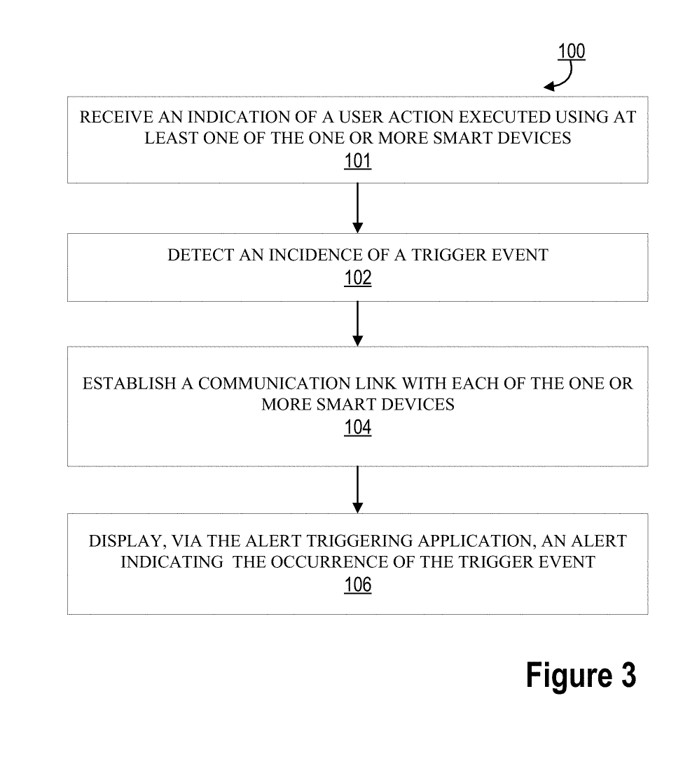

FIG. 3 provides a high level process flow for a system for inter-networked monitoring and communication triggering across a dispersed Internet protocol capable network connecting one or more smart devices connected to the dispersed network 100, in accordance with an embodiment of the invention. Typically, the user may be associated with a resource utilization profile. In some embodiments, the resource utilization profile may include one or more resources allocated to the user. As described herein, the system may be configured to provide the user authorized access to the one or more resources. In this regard, the system may be configured to receive one or more authentication credentials from the user and validate the one or more authentication credentials to enable the user to access the one or more allocated resources. Examples of authentication credentials include, but are not limited to, username, contact information, a password, a PIN number, biometric information (e.g., physiological features such as fingerprints, finger vein and palm vein patterns, as well as iris and facial recognition to verify individual identities), a unique identification number associated with the user, social network information, an account number, or a card number. In some embodiments, the user information may be proprietary to the entity, such as an account number, a reference number to an account, a client number, or the like. In other embodiments, the user information may be public information, such as a phone number, mailing address, email address, or the like.

The present invention provides the functional benefit of determining unauthorized access to the one or more resources associated with the user's resource utilization profile based on preconfigured trigger events specific to each of the one or more resources. In doing so, the present invention is capable of detecting the incidence of a trigger event and in response transmit an alert signal to each of the one or more resources to warn the user of a potentially unauthorized access to the one or more resources. Additionally, the present invention also provides the functional benefit of executing one or more responsive actions according to the trigger event to mitigate the impact of the unauthorized access. In this regard, the actions may be preconfigured by the system and/or the user, or a combination of the two.

As shown in block 101, the system may be configured to receive an indication of a user action executed by the user using at least one of the one or more smart devices. In some embodiments, a user action may include any action associated with the one or more resources that are executed by the user. For example, an action associated with the one or more resources may include, but is not limited to viewing a resource, accessing a resource, using a resource, editing a resource, or the like.

Next, in block 102, the system may be configured to detect an incidence of the trigger event based on at least receiving the indication of the user action executed using at least one of the one or more smart devices. In some embodiments, a trigger event may be one or more preconfigured conditions, which once met, causes another event to occur. In one example, a trigger event may be preconfigured in financial institution systems such as an automated teller machines (ATM) accessible by the user to determine unauthorized access. In another example, a trigger event may be preconfigured in a dispersed network to monitor resource usage statistics and determine reallocation strategies based on preconfigured usage conditions. In yet another example, a trigger event may be preconfigured in smart device connected to a dispersed network hosting multiple other smart devices to detect external unauthorized code, which when infects one smart device in the dispersed network, is capable of affecting all the smart devices.

Next, as shown in block 104, the system may be configured to establish a communication link with each of the one or more smart devices. In some embodiments, by establishing a communication link with each of the one or more smart devices, the system may be configured to activate an alert triggering application stored on each of the one or more smart devices. The alert triggering application is typically provided for installation on each smart device associated with the user. In some embodiments, the alert triggering application may be configured to run continuously in the background. In some other embodiments, the alert triggering application may be configured to not run in the background. Either way, when the system detects the trigger event, the alert triggering application is initiated on each smart device connected to the dispersed network and is displayed in the foreground. In one aspect, if the alert triggering application is not already running in the background of the smart device, by establishing the communication link, the system initiates the alert triggering application and enables the application to execute specific actions while running in the background.

Next, as shown in block 106, the system may be configured to display, via the alert triggering application, an alert indicating the occurrence of the trigger event. In this regard, the system may be configured to transmit control signals configured to cause a display device associated with each of the one or more smart devices to display, via the alert triggering application, an alert indicating the occurrence of the trigger event. In some embodiments, when the alert is pushed to the foreground by the alert triggering application to be displayed on the one or more smart devices. In one aspect, the alert may be an audible tone, a flashing light, a pop up message, a text message, and/or the like.

In some embodiments, the system may be configured to execute one or more responsive actions, via the alert triggering application, on each of the one or more smart devices in response to a trigger event. In one aspect, the one or more responsive actions are executed in addition to transmitting the alert to the one or more smart devices. In another aspect, the one or more responsive actions are executed instead of transmitting the alert to the one or more smart devices. In some embodiments, the one or more responsive actions that are executed may be pre-configured by the system. In some other embodiments, the one or more responsive actions that are executed may be pre-configured by the user. In this regard, the system may be configured to initiate a presentation of a user interface for display on a user device that includes one or more responsive actions to be executed in response to the occurrence of a triggering event. In this way, the system may be configured to receive user input regarding responsive actions to be executed in response to a specific trigger event. In some embodiments, the responsive actions may be global actions executed in response to any trigger event. For example, the responsive action may include restricting all features associated with each of the one or more smart devices in response to a triggering event. In some other embodiments, the responsive action may be local actions executed in response to specific trigger events. For example, the responsive action may include restricting specific features associated with each of the one or more smart devices in response to a triggering event.

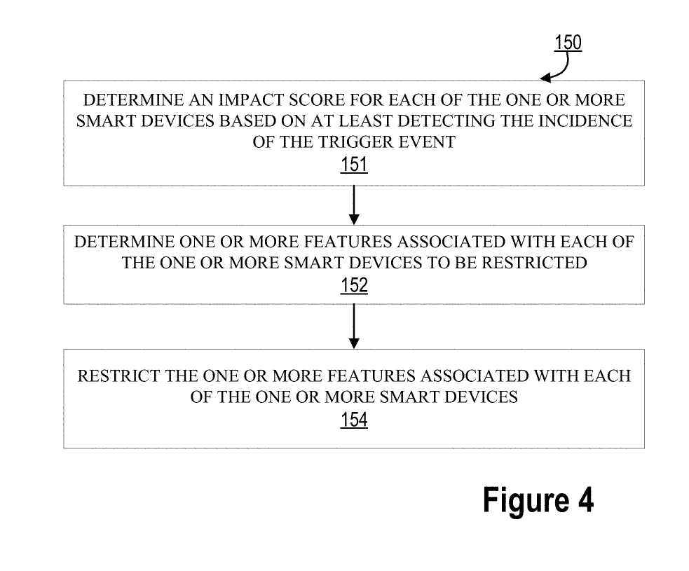

FIG. 4 provides a high level process flow for determining an impact of a trigger event for a system for inter-networked monitoring and communication triggering across a dispersed Internet protocol capable network connecting one or more smart devices connected to the dispersed network 150, in accordance with an embodiment of the invention. As shown in block 151, the system may be configured to determine an impact score for each of the one or more smart devices based on at least detecting the incidence of the trigger event. In this regard, the impact score indicates an impact of the trigger event on each of the one or more smart devices. A higher impact score indicates that the effect of the trigger event is more detrimental to the one or more smart devices than a lower impact score. In some embodiments, each of the one or more smart devices may be associated with an impact score, indicating the effect of the triggering event on each smart device. In such cases, the system may be configured to determine an overall impact score for all the smart devices associated with the user indicating the overall effect of the triggering event on all the smart devices associated with the user.

Next, as shown in block 152, the system may be configured to determine one or more features associated with each of the one or more smart devices to be restricted based on at least the impact score. In some embodiments, the system may be configured to determine which of the one or more features of the one or more smart devices to restrict in order to maximize the reduction of the impact score associated with the one or more smart devices. In one aspect, the one or more features may include both hardware and/or software components associated with the smart device. In this regard, the one or more features may include, but is not limited to an image capturing device, a microphone, a speaker, and/or one or more applications such as an online banking application, an e-mail application, and/or the like.

Next, as shown in block 154, the system may be configured to restrict the one or more features associated with each of the one or more smart devices. In this regard, the system may be configured to transmit control signals configured to restrict the one or more features associated with each of the one or more smart devices. In one example, the system may disable a radio circuit configured to connect each of the one or more smart devices to the dispersed network. By disabling the radio circuit, the system may disconnect each of the one or more smart devices from the dispersed network. In another example, the system may disable one or more devices associated with each of the one or more smart devices. By disabling the one or more devices (e.g., image capturing device), the system may be configured to disconnect the one or more devices associated with each of the one or more smart devices from the dispersed network.

By way of one example, the system may be configured to determine that an integration code associated with a device (e.g., ATM, fuel terminal, computer system, or the like) has been compromised due to a user action executed by the user. In response, the system may be configured to determine whether the integration code (e.g., default set of system parts, manufacturer seal, authenticity of the parts, or the like) compromised was due to an external exposure or an internal exposure. Typically, an internal exposure occurs when an individual or a group within the entity seeks to disrupt operations or exploit entity assets by launching a sophisticated device exposure and potentially remove any evidence of the exposure as well. An external exposure occurs when an individual or group outside the entity seeks to disrupt operations or exploit entity assets. In response to determining that the integration code has been compromised, the system may be configured to initiate one or more responsive actions to mitigate the impact of the exposure.

By way of another example, the system may be configured to monitor one or more financial institution systems for use beyond what was initially requested by the user. In response, the system may be configured to initiate one or more responsive actions to mitigate the impact of the excessive use.

By way of yet another example, the system may be configured to retrieve information associated with a financial instrument and/or the smart device used by the user to execute the user action. In one aspect, the information may include one or more rules assigned to the financial instrument associated with the execution of a user action. The system may then determine whether the user action executed by the user is no longer within the rails of the one or more rules. In response, the system may be configured to initiate one or more responsive actions to mitigate the impact of the excessive use.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for inter-networked monitoring and communication triggering across a dispersed Internet protocol capable network connecting one or more smart devices connected to the dispersed network, the system comprising:
at least one memory;
at least one processing device operatively coupled to the memory device, wherein the processing device is configured to execute computer-readable program code to:
provide an alert triggering application for installation on the one or more smart devices associated with a user;
receive an indication of a user action executed by the user;
detect an incidence of a trigger event based on at least receiving the indication of the user action executed using at least one of the one or more smart devices;
establish a communication link with each of the one or more smart devices based on at least detecting the incidence of the trigger event, wherein establishing further comprises activating the alert triggering application stored on each of the one or more smart devices; and
transmit control signals configured to cause a display device associated with each of the one or more smart devices to display, via the alert triggering application, an alert indicating the occurrence of the trigger event.

2. The system of claim 1, wherein the module is further configured to:
transmit control signals configured to execute one or more actions, via the alert triggering application, on each of the one or more smart devices.

3. The system of claim 2, wherein the module is further configured to:
initiate a presentation of a user interface for display on a user device, wherein the user interface comprises the one or more actions to be executed in response to the occurrence of the triggering event; and
receive, via the user interface, a user selection of one or more actions to be executed on each of the one or more smart devices in response to the occurrence of the triggering event.

4. The system of claim 2, wherein the one or more actions comprises restricting one or more features associated with each of the one or more smart devices.

5. The system of claim 2, wherein the module is further configured to:
determine an impact score for each of the one or more smart devices based on at least detecting the incidence of the trigger event, wherein the impact score indicates an impact of the trigger event on each of the one or more smart devices;
determine one or more features associated with each of the one or more smart devices to be restricted based on at least the impact score; and
transmit control signals configured to restrict the one or more features associated with each of the one or more smart devices.

6. The system of claim 1, wherein the module is further configured to:
transmit control signals configured to disable a radio circuit configured to connect each of the one or more smart devices to the dispersed network, wherein disabling further comprises disconnecting each of the one or more smart devices from the dispersed network.

7. The system of claim 6, wherein the module is further configured to:
transmit control signals configured to disable one or more devices associated with each of the one or more smart devices, wherein disabling further comprises disconnecting the one or more devices associated with each of the one or more smart devices from the dispersed network.

8. A computerized method for inter-networked monitoring and communication triggering across a dispersed Internet protocol capable network connecting one or more smart devices connected to the dispersed network, the method comprising:
providing, using a computing device processor, an alert triggering application for installation on the one or more smart devices associated with a user;
receiving, using a computing device processor, an indication of a user action executed using at least one of the one or more smart devices;
detecting, using a computing device processor, an incidence of a trigger event based on at least receiving the indication of the user action executed using at least one of the one or more smart devices;
establishing, using a computing device processor, a communication link with each of the one or more smart devices based on at least detecting the incidence of the trigger event, wherein establishing further comprises activating the alert triggering application stored on each of the one or more smart devices; and
transmitting, using a computing device processor, control signals configured to cause a display device associated with each of the one or more smart devices to display, via the alert triggering application, an alert indicating the occurrence of the trigger event.

9. The method of claim 8, wherein the method further comprises:
transmitting control signals configured to execute one or more actions, via the alert triggering application, on each of the one or more smart devices.

10. The method of claim 9, wherein the method further comprises:
initiating a presentation of a user interface for display on the at least one of the one or more smart devices, wherein the user interface comprises the one or more actions to be executed in response to the occurrence of the triggering event; and
receiving, via the user interface, a user selection of one or more actions to be executed on each of the one or more smart devices in response to the occurrence of the triggering event.

11. The method of claim 9, wherein the one or more actions comprises restricting one or more features associated with each of the one or more smart devices.

12. The method of claim 9, wherein the method further comprises:
determining an impact score for each of the one or more smart devices based on at least detecting the incidence of the trigger event, wherein the impact score indicates an impact of the trigger event on each of the one or more smart devices;
determining one or more features associated with each of the one or more smart devices to be restricted based on at least the impact score; and
transmitting control signals configured to restrict the one or more features associated with each of the one or more smart devices.

13. The method of claim 8, wherein the method further comprises:
transmitting control signals configured to disable a radio circuit configured to connect each of the one or more smart devices to the dispersed network, wherein disabling further comprises disconnecting each of the one or more smart devices from the dispersed network.

14. The method of claim 13, wherein the method further comprises:
transmitting control signals configured to disable one or more devices associated with each of the one or more smart devices, wherein disabling further comprises disconnecting the one or more devices associated with each of the one or more smart devices from the dispersed network.

15. A computer program product for inter-networked monitoring and communication triggering across a dispersed Internet protocol capable network connecting one or more smart devices connected to the dispersed network, the computer program product comprising a non-transitory computer-readable medium comprising code causing a first apparatus to:
provide an alert triggering application for installation on the one or more smart devices associated with a user;
receive an indication of a user action executed using at least one of the one or more smart devices;
detect an incidence of a trigger event based on at least receiving the indication of the user action executed using at least one of the one or more smart devices;
establish a communication link with each of the one or more smart devices based on at least detecting the incidence of the trigger event, wherein establishing further comprises activating the alert triggering application stored on each of the one or more smart devices; and
transmit control signals configured to cause a display device associated with each of the one or more smart devices to display, via the alert triggering application, an alert indicating the occurrence of the trigger event.

16. The computer program product of claim 15, wherein the first apparatus is further configured to:
transmit control signals configured to execute one or more actions, via the alert triggering application, on each of the one or more smart devices.

17. The computer program product of claim 16, wherein the first apparatus is further configured to:
initiate a presentation of a user interface for display on the at least one of the one or more smart devices, wherein the user interface comprises the one or more actions to be executed in response to the occurrence of the triggering event; and
receive, via the user interface, a user selection of one or more actions to be executed on each of the one or more smart devices in response to the occurrence of the triggering event.

18. The computer program product of claim 16, wherein the one or more actions comprises restricting one or more features associated with each of the one or more smart devices.

19. The computer program product of claim 16, wherein the first apparatus is further configured to:
determine an impact score for each of the one or more smart devices based on at least detecting the incidence of the trigger event, wherein the impact score indicates an impact of the trigger event on each of the one or more smart devices;
determine one or more features associated with each of the one or more smart devices to be restricted based on at least the impact score; and
transmit control signals configured to restrict the one or more features associated with each of the one or more smart devices.

20. The computer program product of claim 15, wherein the first apparatus is further configured to:
transmit control signals configured to disable a radio circuit configured to connect each of the one or more smart devices to the dispersed network, wherein disabling further comprises disconnecting each of the one or more smart devices from the dispersed network.
